(19) United States
(12) Patent Application Publication
(10) Pub. No.: US 2012/0259869 A1
(43) Pub. Date: Oct. 11, 2012

(54) SYSTEM AND METHOD FOR IMPLEMENTING A WINDOW SORTING MECHANISM

(75) Inventor: Pramit John PUNNILETHU, Gujarat (IN)

(73) Assignee: INFOSYS TECHNOLOGIES, LTD., Bangalore (IN)

(21) Appl. No.: 13/221,176

(22) Filed: Aug. 30, 2011

(30) Foreign Application Priority Data
Apr. 7, 2011 (IN) 1219/CHE/2011

(51) Int. Cl. G06F 17/30

(52) U.S. Cl. 707/752; 707/E17.045

(57) ABSTRACT

A system and method of providing a window sorting mechanism comprises receiving an array having a plurality of objects, wherein each object contains a digit. The digits in the received array are unsorted in association with a desired sorting arrangement. A length of the received array is determined, whereby received array is separated into a plurality of sub-arrays based on the length of the received array. An inter sub-array digit sorting process is performed in a first iteration between a first sub-array and a second sub-array to sort digits in correspondingly positioned objects in accordance with a first comparison rule. A first adjacent-object digit sorting process is performed in a second iteration on the first and second sub-arrays using simultaneously sorting windows of a first digit size in accordance with a second comparison rule. A second adjacent-object digit sorting process is then performed in a third iteration on the first and second sub-arrays using sorting windows of a second digit size.

This application claims the benefit of Indian Patent Application Filing No. 1219/CHE/2011, filed Apr. 7, 2011, which is hereby incorporated by reference in its entirety.

### FIELD

The present disclosure relates to a system and method for implementing a window sorting mechanism.

### BACKGROUND

On modern computers, locality of reference can be of paramount importance in software optimization, because multilevel memory hierarchies are used. Cache-aware versions of the merge sort algorithm, whose operations have been specifically chosen to minimize the movement of pages in and out of a machine's memory cache, have been proposed. For example, the tiled merge sort algorithm stops partitioning subarrays when subarrays of size S are reached, where S is the number of data items fitting into a CPU's cache. Each of these subarrays is sorted with an in-place sorting algorithm, to discourage memory swaps, and normal merge sort is then completed in the standard recursive fashion.

On typical modern architectures, merge sort is a stable sort, parallelizes better, and is more efficient than other sorting techniques at handling slow-to-access sequential media. Merge sort is often the best choice for sorting a linked list. In this situation, a merge sort can be implemented in a way that it requires only Θ(1) extra space, and the slow random-access performance of a linked list makes some other sorting algorithms perform poorly.

Merge sort's merge operation is useful in online sorting, where the list to be sorted is received a piece at a time. However, this approach can be expensive in time and space if the received pieces are small compared to the entire sorted list. Further, merge sort is computed using a multitude of iterations which are directly based on the size of the array to be sorted. This can result in lengthy operations due to the number of iterations that the merge sort must perform to sort the array into desired form.

Bubble sort is another type of sorting mechanism that is much simpler compared to merge sort. However, bubble sort interacts poorly with modern CPU hardware. It requires at least twice as many writes, twice as many cache misses, and asymptotically more branch mispredictions.

What is needed is a window sorting module which is simpler, faster and more efficient than the merge sorting and bubble sorting techniques described above.

### SUMMARY

In an aspect, a method of providing a window sorting mechanism comprises executing a window sorting mechanism that is implemented on a network device. The method comprises receiving an array having a plurality of objects, wherein each object contains a digit. The digits in the received array are unsorted in association with a desired sorting arrangement. The method comprises determining a length of the received array and separating the received array into a plurality of sub-arrays based on the length of the received array. At least two of the plurality of sub-arrays comprises a first sub-array and a second sub-array, wherein the first and second sub-arrays having an equal number of objects. The method comprises performing an inter sub-array digit sorting process in a first iteration between the first sub-array and the second sub-array to sort digits in correspondingly positioned objects of the first and second sub-arrays in accordance with a first comparison rule. The method comprises performing a first adjacent-object digit sorting process in a second iteration on at least the first and second sub-arrays using a plurality of sorting windows of a first determined digit size. At least two sorting windows simultaneously sort digits in adjacent objects in the first and second sub-arrays in accordance with a second comparison rule to produce a first modified array having digits sorted in compliance with the desired sorting arrangement.

In an aspect, a non-transitory machine readable medium having stored thereon instructions for providing a window sorting module. The medium comprises machine executable code, which when executed by at least one machine, causes the machine to execute a window sorting mechanism implemented on a network device. The code causes the machine to receive an array having a plurality of objects, wherein each object contains a digit. The digits in the received array are unsorted in association with a desired sorting arrangement. The code causes the machine to determine a length of the received array and separate the received array into a plurality of sub-arrays based on the length of the received array. At least two sub-arrays comprise a first sub-array and a second sub-array, wherein the first and second sub-arrays have an equal number of objects. The code causes the machine to perform an inter sub-array digit sorting process in a first iteration between the first sub-array and the second sub-array to sort digits in correspondingly positioned objects of the first and second sub-arrays in accordance with a first comparison rule. The code causes the machine to perform a first adjacent-object digit sorting process in a second iteration on at least the first and second sub-arrays. This sorting process uses a plurality of sorting windows of a first determined digit size, wherein at least two sorting windows simultaneously sort digits in adjacent objects in the first and second sub-arrays in accordance with a second comparison rule to produce a first modified array.

In an aspect, a computer system comprises a network interface configured to allow communications between the computing system and one or more network devices. The computer system includes a memory and a processor coupled to the network interface and the memory. The processor is operative to execute a window sorting mechanism implemented on a network device. The processor is operative to receive an array having a plurality of objects, wherein each object contains a digit. The digits in the received array are unsorted in association with a desired sorting arrangement. The processor is operative to determine a length of the received array and separate the received array into a plurality of sub-arrays based on the length of the received array. At least two sub-arrays comprise a first sub-array and a second sub-array each having an equal number of objects. The processor is operative to perform an inter sub-array digit sorting process in a first iteration between the first sub-array and the second sub-array to sort digits in correspondingly positioned objects of the first and second sub-arrays in accordance with a first comparison rule. The processor is operative to perform a first adjacent-object digit sorting process in a second iteration on at least the first and second sub-arrays using a plurality of sorting windows of a first determined digit size, wherein at least two sorting windows simultaneously sort digits in adjacent objects in the first and second sub-arrays in accordance with a second comparison rule to produce a first modified array.

In one or more of the above aspects, it is determined if the modified array contains digits sorted in compliance with the desired sorting arrangement after the second iteration. If not, a second adjacent-object digit sorting process is performed in a third iteration on at least the first and second sub-arrays using a plurality of sorting windows of a second determined digit size. The sorting windows simultaneously sort digits in adjacent objects in the first and second sub-arrays in accordance with a third comparison rule to produce a second modified array having digits sorted in compliance with the desired sorting arrangement. The second modified array is then outputted.

In one or more of the above aspects, the first determined digit size comprises a two digit sorting window and the second determined digit size comprises a three digit sorting window.

In one or more of the above aspects, performance of the first adjacent-object digit sorting process further comprises: comparing a first pair of digits in a first pair of adjacent objects in at least the first sub-array using the first sorting window according to the second comparison rule; and swapping the digits in the first pair if the values of the digits satisfy the second comparison rule.

In one or more of the above aspects, performance of the first adjacent-object digit sorting process further comprises: comparing a second pair of digits in a second pair of adjacent objects in at least the second sub-array using the second sorting window according to the second comparison rule; and swapping the digits in the second pair if the values of the digits satisfy the second comparison rule.

In one or more of the above aspects, performance of the first adjacent-object digit sorting process further comprises: moving the first and second sorting windows incrementally along the first and second sub-arrays toward one another in a converging fashion; overlapping the first and second sorting windows on one or more objects of the first and second sorting windows; and moving the first and second sorting windows incrementally along the first and second sub-arrays away one another in a diverging fashion.

### BRIEF DESCRIPTION OF THE DRAWINGS

FIG. 1 illustrates a diagram of an example system environment that utilizes a window sorting mechanism in accordance with an aspect of the present disclosure;

FIG. 2A illustrates a block diagram of a client device implementing at least a portion of the window sorting mechanism in accordance with an aspect of the present disclosure;

FIG. 2B illustrate a block diagram of a server implementing at least a portion of the window sorting mechanism in accordance with an aspect of the present disclosure;

FIGS. 3A-3T illustrates an example block diagram of an unsorted array that is processed by a window sorting module in accordance with an aspect of the present disclosure; and

FIG. 4 is an example flow chart diagram depicting portions of processes performed by at least the window sorting module in accordance with the present disclosure.

### DETAILED DESCRIPTION

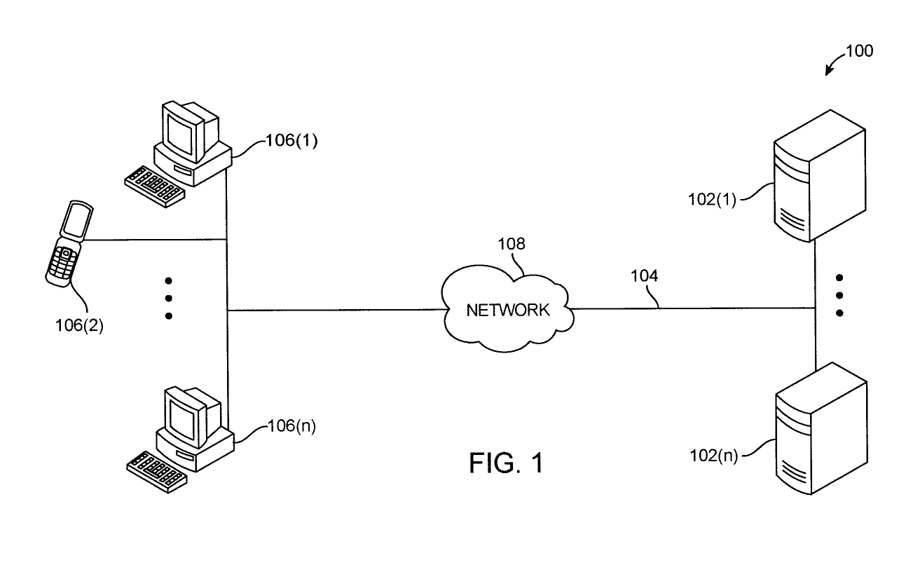

FIG. 1 illustrates a diagram of an example system environment that implements and executes a novel window sorting mechanism and method of use in accordance with an aspect of the present disclosure. In particular, the example system environment 100 includes one or more servers 102(1)-102(n). The environment 100 includes one or more client devices 106(1)-106(n), although the environment 100 could include other numbers and types of devices in other arrangements. It should be noted that the term “network devices” can be referred to as encompassing one or more client devices, one or more servers and/or other hardware components in the system 100.

The servers 102(1)-102(n) are connected to a local area network (LAN) 104 and the client devices 106(1)-106(n) are connected to a wide area network 108, whereby the one or more client devices 106(1)-106(n) communicate with the one or more servers 102(1)-102(n) via the wide area network 108 and LAN 104. It should be noted that although the client device and/or server may be referred to herein in the plural, it is contemplated that only one client device and/or one server may be considered without being limiting to the language used herein. It should be understood that the particular configuration of the system 100 shown in FIG. 1 are provided for exemplary purposes only and is thus not limiting.

Client devices 106(1)-106(n) comprise computing devices capable of connecting to other computing devices, such as the servers 102(1)-102(n). Such connections are performed over wired and/or wireless networks, such as network 108, to send and receive data, such as for Web-based and non Web-based requests, receiving responses to requests and/or performing other tasks, in accordance with the novel processes described herein. Non-limiting and non-exhausting examples of such client devices 106(1)-106(n) include, but are not limited to, personal computers (e.g., desktops, laptops), mobile and/or smart phones, kiosks, ATMs, tablet devices, PDAs and the like.

In an example, client devices 106(1)-106(n) may be configured to run a Web browser or other software module that provides a user interface for human users to interact with, request resources and/or information, as well as submit instructions over the network 108 to the one or more servers 102(1)-102(n) via Web-based or non Web-based applications. One or more Web-based or non Web-based applications may accordingly run on the servers 102(1)-102(n) that provide the requested data to the client device 106(1)-106(n) and/or perform the requested instructions on behalf of the user. In an example, the client device 106 may be a smart phone, tablet, or smart television in which the client devices 106(1)-106(n) communicate with the servers 102(1)-102(n) via a mobile application (i.e. “mobile app”).

Network 108 comprises a publicly accessible network, such as the Internet, which handles communication between the client devices 106(1)-106(n) and the servers 102(1)-102(n). However, it is contemplated that the network 108 may comprise other types of private and public networks. Communications, such as requests from client devices 106(1)-106(n) and responses from servers 102(1)-102(n), preferably take place over the network 108 according to standard network protocols, such as the HTTP, UDP, and TCP/IP protocols and the like.

Further, it should be appreciated that the network 108 may include local area networks (LANs), wide area networks (WANs), direct connections and any combination thereof, as well as other types and numbers of network types. On an interconnected set of LANs or other networks, including those based on differing architectures and protocols, routers, switches, hubs, gateways, bridges, and other intermediate network devices may act as links within and between LANs, WANs and other networks to enable messages and other data to be sent and received between network devices. Also, communication links within and between LANs and other networks typically include twisted wire pair (e.g., Ethernet), coaxial cable, analog telephone lines, mobile cell towers, full or fractional dedicated digital lines including T1, T2, T3, and T4, Integrated Services Digital Networks (ISDNs), Digital Subscriber Lines (DSLs), wireless links including satellite links and other communications links known to those skilled in the relevant arts.

LAN 104 may comprise one or more private and public networks which provide secured access to the servers 102(1)-102(n). These types of existing standardized messaging schemes used between financial institutions over WANs and LANs is well known and is not described in detail herein.

The servers 102(1)-102(n) comprise one or more network devices or machines capable of operating one or more Web-based and/or non Web-based applications that may be accessed by other network devices (e.g. client devices, other servers) in the network 108. Such data includes, but is not limited to Web page(s), image(s) of physical objects, user account information, and any other objects and information. It should be noted that the servers 102(1)-102(n) may perform other tasks and provide other types of resources.

As will be discussed in more detail below, one or more servers 102 may comprise a cluster of a plurality of servers which are managed by a network traffic management device (e.g. firewall, load balancer, web accelerator), gateway device, router, hub and the like. In an aspect, one or more servers 102(1)-102(n) may implement a version of Microsoft® IIS servers, RADIUS servers and/or Apache® servers, although other types of servers may be used and other types of applications may be available the on servers 102(1)-102(n).

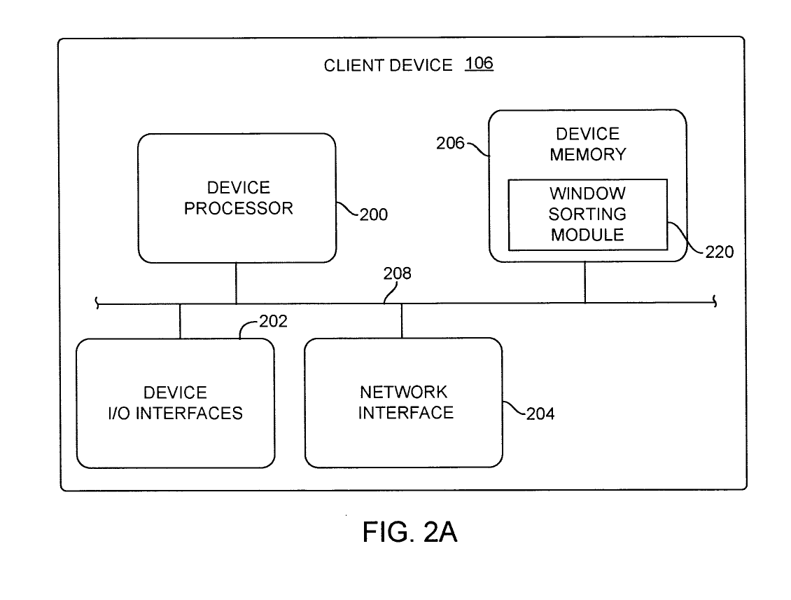

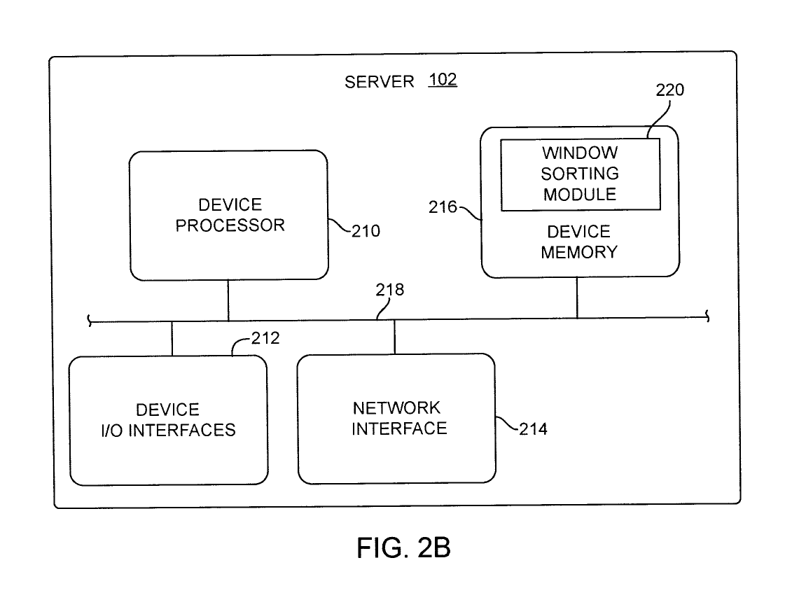

FIG. 2A illustrates a block diagram of a client device 106 shown in FIG. 1 in accordance with an aspect of the present disclosure. As shown in FIG. 2A, an example client device 106 includes one or more device processors 200, one or more device I/O interfaces 202, one or more network interfaces 204 and one or more device memories 206, all of which are coupled together by one or more buses 208. It should be noted that the device 106 could include other types and numbers of components.

FIG. 2B illustrates a block diagram of a server 102 shown in FIG. 1 in accordance with an aspect of the present disclosure. With regard to FIG. 2B, an example server 102 is shown which includes one or more device processors 210, one or more device I/O interfaces 212, one or more network interfaces 214 and one or more device memories 216, all of which are coupled together by one or more buses 218. It should be noted that the server 102 could include other types and numbers of components.

Device processor 200, 210 comprises one or more microprocessors configured to execute computer/machine readable and executable instructions stored in the respective local device memory 206, 216 or in a remote device memory (not shown). Such instructions are implemented by the processor 200, 210 to perform one or more functions described below. It is understood that the processor 200, 210 may comprise other types and/or combinations of processors, such as digital signal processors, micro-controllers, application specific integrated circuits (“ASICs”), programmable logic devices (“PLDs”), field programmable logic devices (“FPLDs”), field programmable gate arrays (“FPGAs”), and the like. The processor 200, 210 is programmed or configured to execute the process in accordance with the teachings as described and illustrated herein of the novel system and method described below.

Device I/O interfaces 202, 212 comprise one or more user input and output device interface mechanisms. The interface may include a computer keyboard, touchpad, touchscreen, mouse, display device, and the corresponding physical ports and underlying supporting hardware and software to enable communications with other network devices in the system 100. Such communications include, but are not limited to, accepting user data input and providing output information to a user, programming, accessing one or more memory devices and administering one or more functions to be executed by the corresponding device and the like.

Network interface 204, 214 comprises one or more mechanisms that enable the client devices 106 and/or the servers 102 to engage in TCP/IP or other communications over the LAN 104 and network 108. However, it is contemplated that the network interface 204, 214 may be constructed for use with other communication protocols and types of networks. Network interface 204, 214 is sometimes referred to as a transceiver, transceiving device, or network interface card (NIC), which transmits and receives network data packets over one or more networks, such as LAN 104 and network 108.

In an example where the client device 106 and/or server 102 includes more than one device processor 200, 210 (or a processor 200, 210 has more than one core), each processor 200, 210 (and/or core) may use the same single network interface 204, 214 or a plurality of network interfaces 204, 214 to communicate with other network devices. Further, the network interface 204, 214 may include one or more physical ports, such as Ethernet ports, to couple its respective device with other network devices in the system 100. Moreover, the network interface 204, 214 may include certain physical ports dedicated to receiving and/or transmitting certain types of network data, such as device management related data for configuring the respective device, and the like.

Bus 208, 218 may comprise one or more internal device component communication buses, links, bridges and supporting components, such as bus controllers and/or arbiters. The bus enable the various components of the device 102, 106, such as the processor 200, 210, device I/O interfaces 202, 212, network interface 204, 214, and device memory 206, 216, to communicate with one another. However, it is contemplated that the bus may enable one or more components of its respective device 102, 106 to communicate with components in other devices as well. Example buses include HyperTransport, PCI, PCI Express, InfiniBand, USB, Firewire, Serial ATA (SATA), SCSI, IDE and AGP buses. However, it is contemplated that other types and numbers of buses may be used, whereby the particular types and arrangement of buses will depend on the particular configuration of the device 102, 106 which houses the bus.

Device memory 206, 216 of the client device 106 or server 102 comprises computer readable media, namely computer readable or processor readable storage media, which are examples of machine-readable storage media. Computer readable storage/machine-readable storage media may include volatile, nonvolatile, removable, and non-removable media implemented in any method or technology for storage of information. Such storage media stores computer readable/machine-executable instructions, data structures, program modules and components, or other data, which may be obtained and/or executed by one or more processors, such as device processor 200, 210. Such stored instructions allow the processor to perform actions, including implementing an operating system for controlling the general operation of the client device 106 and/or server 102 to perform one or more portions of the novel process described below.

Examples of computer readable storage media include RAM, BIOS, ROM, EEPROM, flash/firmware memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Such desired information includes data and/or computer/machine-executable instructions and which can be accessed by the network devices 102, 106.

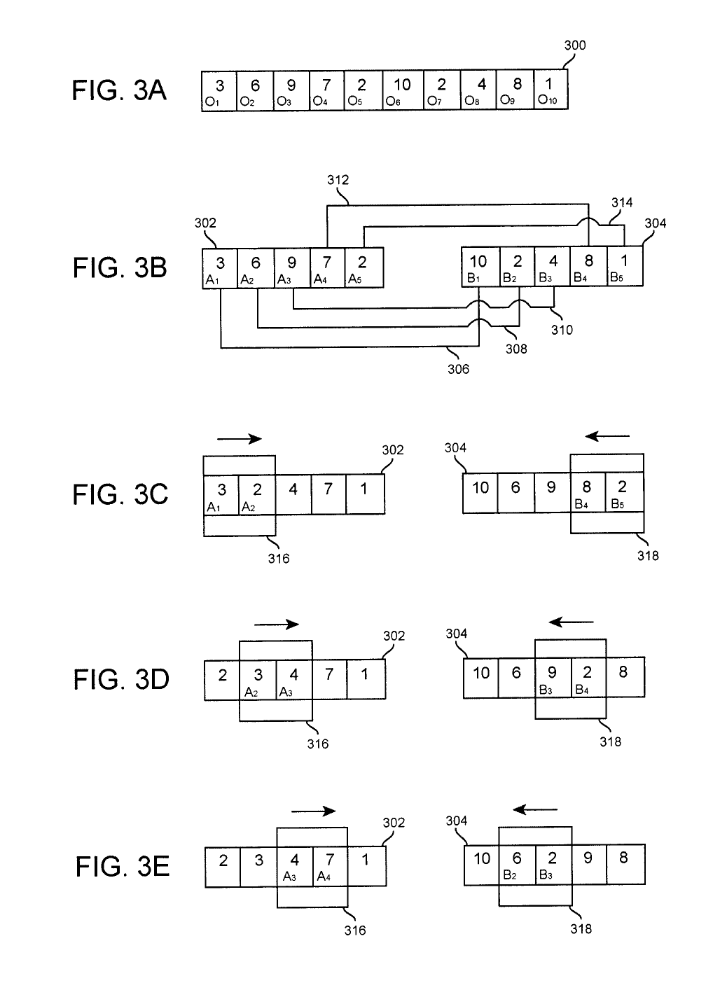

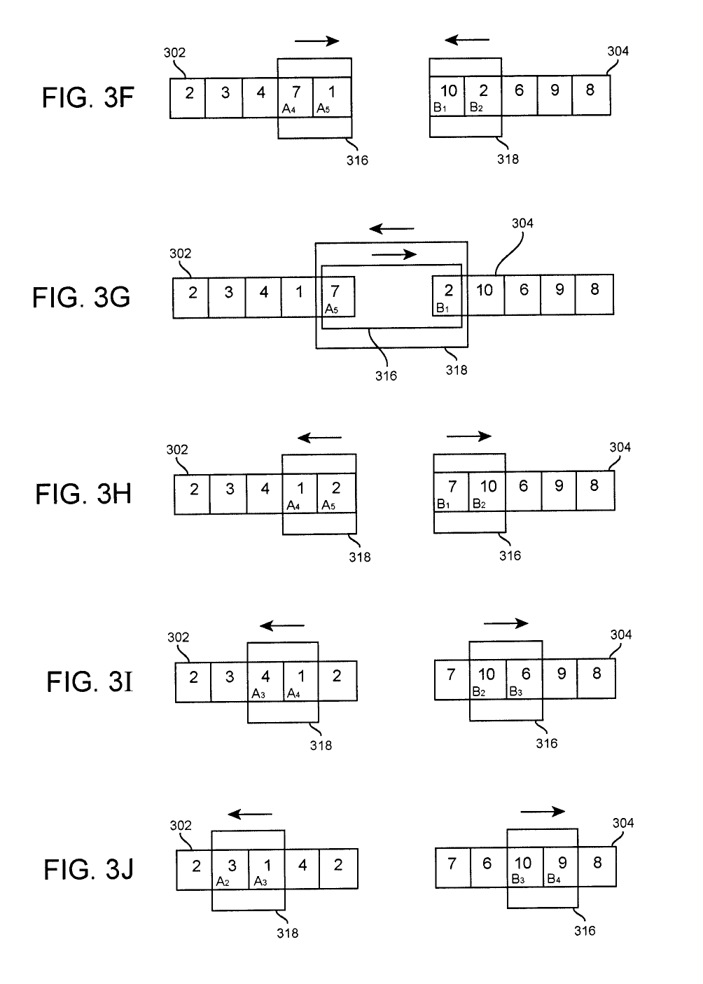

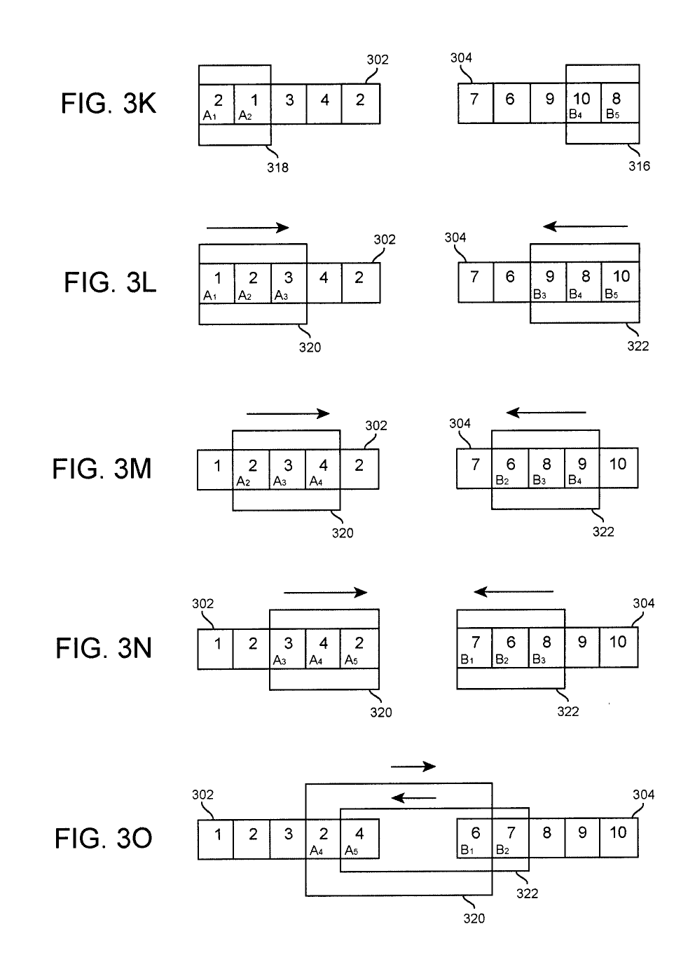

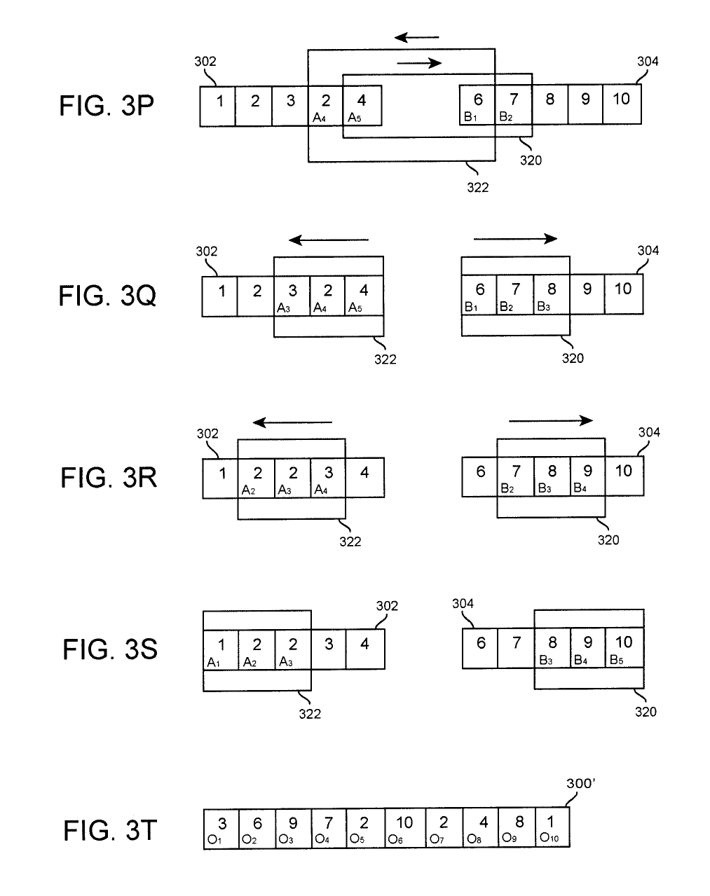

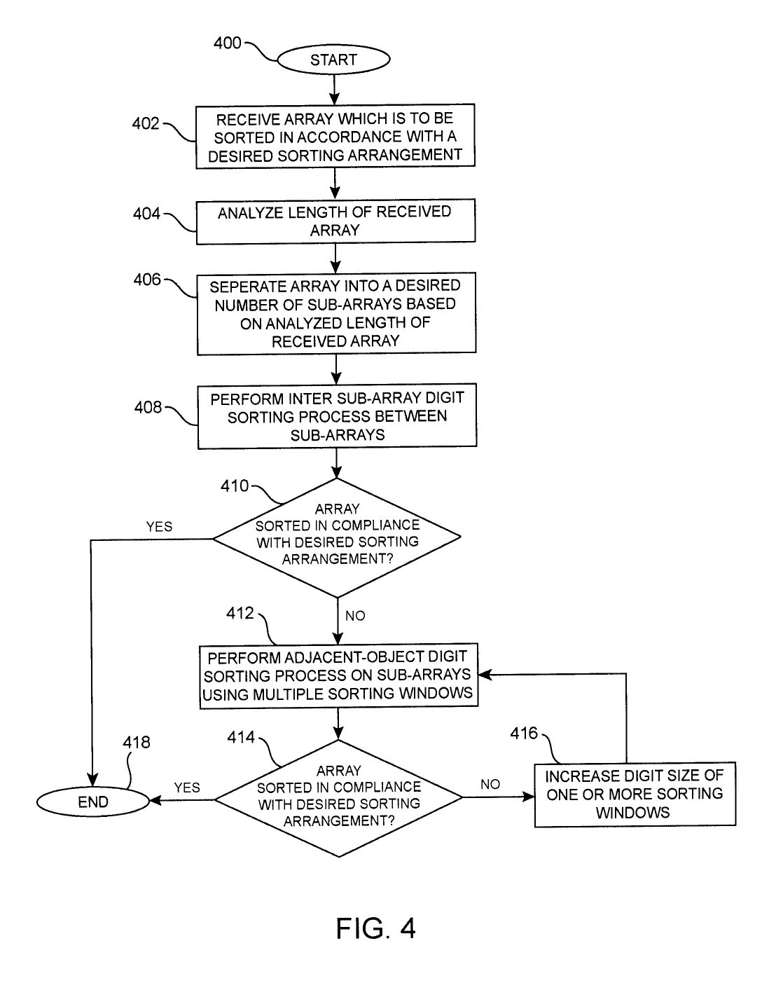

The window sorting module 220 performs the functions described below in relation to FIGS. 3A-3T and 4. The window sorting module 220 is depicted in FIGS. 2A-2B as being within the memory 206, 216 for exemplary purposes only, and it should be appreciated the window sorting module 220 may be alternatively located elsewhere. Generally, when instructions embodying the window sorting module 220 are executed by the device processor 200, 210 in the client device 106 and/or server 102, to perform the functions described in FIGS. 3A-3T and 4.

FIGS. 3A-3T as well as 4 illustrate an example process of the use of the multiple window sorting technique performed by a processing device implementing the window sorting module 220 to sort an array in compliance with a desired sorting arrangement. In the example shown in FIGS. 3A-3T, the window sorter module performs a sorting technique in which the received original array 300 will be sorted to produce a modified array 300′, whereby the desired sorting arrangement is defined such that the modified array 300′ is sorted such that its digits will be in overall increasing order from a first object Oᵢ to the last object Oₙ (FIG. 3T).

FIG. 3A illustrates an array 300 containing a plurality of objects 301 in which each object contains a character (e.g. letter, digit of a certain value, symbol). For purposes of the example, digits are contained in the objects, although it should be noted that the system and method is not limited to sorting digits. The process initiates (Start Block in FIG. 4) where an unsorted array 300 is received, whereby the array 300 contains two or more digits which are not sorted in compliance with a desired sorting arrangement (Block 402 in FIG. 4). In particular to the example in FIGS. 3A-3T, the array 300 is in an unsorted state when it is received. For purposes of explanation, each object 301 has a corresponding position (O₁, O₂, O₃ . . . Oₙ) in the array 300. For example in FIG. 3A, the objects 301 in the array 300 have positions ordered as (O₁, O₂, O₃ . . . O₁₀). In the example, the object at position O₁ has an original digit value of 3; the object at position O₄ has an original digit value of 7; the object at position O₇ has an original digit value of 2; and the object at position O₁₀ has an original digit value of 1.

The process initiates with the window sorter module 220 determining the total number of objects (O₁, O₂, . . . Oₙ) in the array 300 (Block 404 in FIG. 4). As stated above with respect to the example shown, the array 300 contains 10 objects, although any larger or smaller number of objects are contemplated. During a first iteration, the window sorter module separates or organizes the array 300 into a plurality of sub-arrays based on the total number of objects (Block 406 in FIG. 4). In an aspect, the number of sub-arrays can be determined based on the total number of objects in the array 300. In an aspect, at least two sub-arrays have an equal number of objects. In another aspect, none of the sub-arrays have any equal number of objects.

In the example, shown in FIG. 3B, the window sorter module separates the array 300, which contains 10 total objects, into two sub-arrays 302, 304, each which contain 5 objects (Block 406 in FIG. 4), although any other number of objects are contemplated. It should be noted that during the first iteration, the objects and their digit values remain in their original positions when the array is divided into a plurality of sub-arrays. In particular to the example, a first sub-array 302 includes objects A₁-A₅ and a second sub-array 304 includes objects B₁-B₅, wherein each object maintains its digit value with respect to the original order in which the array 300 was received.

After the array 300 is divided into the first and second sub-arrays 302, 304 in the first iteration, the window sorter module begins an inter sub-array digit sorting process (Block 408 in FIG. 4). In particular, the inter sub-array digit sorting process comprises the window sorter module comparing the digit in each object in one sub-array with the digit in each object in another sub-array, wherein the corresponding compared objects are in the same position within their respective sub-array. The window sorter module is configured to perform the comparison of digits in designated related objects in accordance with a pre-defined comparison rule. If the window sorter module, upon comparing the digits, determines that the rule has been satisfied, the window sorter module will swap or exchange the compared digits from their original objects to the new object. The comparison rule can be established and defined by a software engineer, network administrator, hardware designer and the like, whereby it is implemented in the window sorting module 220.

In performing the inter sub-array digit sorting process, the comparison rule implemented by the window sorter module 220 is as such:
If digit_{Ai}>digit_{Bi}; then swap digits
If digit_{Ai}<digit_{Bi}; then do not swap digits
If digit_{Ai}=digit_{Bi}; then do not swap digits

Accordingly, as shown by arrow 306 in FIG. 3B, the window sorter module 220 compares the digit in object A₁ (which has a digit value of 3) with the digit in object B₁ (which has a digit value of 10). Based on the above comparison rule, since the digit value of 3 is less than the digit value of 10, the digits are not swapped. This is reflected in FIG. 3C where the digits 3 and 10 remain in their objects within their respective sub-arrays.

Moving on, as shown by arrow 308, the window sorter module compares the digit in object A₂ (which is the value 6) with the digit in object B₂ (which is the value 2). Based on the above comparison rule, since the value of 6 is greater than the value of 2, the digits are swapped. This is reflected in FIG. 3C where the digit 2 is now placed in object A₂ and digit 6 is now placed in object B₂. This process repeats, preferably within the same iteration, with the remainder objects where the digits are swapped (or not-swapped) in accordance with the comparison rule. As represented in FIG. 3C, the digits in objects A₃, B₃, A₅ and B₅ are swapped whereas objects A₄ and B₄ are not swapped by the window sorter module. By initially performing the inter sub-array digit sorting process, the window sorter module is able to gather two or more digit values that are sequentially close to one another along a typical number line into a common sub-array. As shown in FIG. 3C, the digits 3, 2, 4, and 1 (with the exception of digit 7) are gathered in the first sub-array 302 whereas digits 10, 6, 9, and 8 (with the exception of digit 3) are gathered in the second sub-array 304.

After performing the inter sub-array digit sorting process, the window sorter module 220 determines whether the array is sorted in compliance with the desired sorting arrangement (Block 410 in FIG. 4). If so, the process terminates and the sorted sub-arrays are rejoined to create the modified sorted array 300′. In contrast, if the window sorter module 220 determines that the array is not sorted in compliance with the desired sorting arrangement (Block 410 in FIG. 4), the window sorter module 220 initiates a second iteration process.

In particular, in the second iteration, the window sorter module 220 performs a neighbor or adjacent-object digit sorting process (Block 412 in FIG. 4). In particular, the adjacent-object digit sorting process comprises the window sorting module 220 implementing two or more sliding sorting windows 316, 318 of predetermined size which simultaneously perform 302, 304 comparison and swapping logic on digits which are in objects that are positioned next to one another. In an aspect, the two or more sliding sorting windows 316, 318 begin the process at opposite ends of their own sub-arrays. After performing the comparison and swapping process, each sliding sorting window incrementally moves toward each other in a converging fashion until they overlap and begin moving toward opposite ends of the other sub-array in a diverging fashion. More details of this process is discussed below.

In performing the adjacent-object digit sorting process, each sliding window compares digits between neighboring objects in accordance with a comparison rule. If the window sorter module, upon comparing the digits, determines that the rule has been satisfied, the window sorter module will swap or exchange the compared digits from their original objects to the new object. The comparison rule can be established and defined by a software engineer, network administrator, hardware designer and the like, whereby it is implemented in the window sorting module 220.
If digit_{Oi}>digit_{Oi+i}; then swap digits
If digit_{Oi}<digit_{Oi+i}; then do not swap digits
If digit_{Oi}=digit_{Oi+i}; then do not swap digits

Where digit_{Oi} is the digit on the left hand side of a two-digit sorting window and digit_{Oi+i} is the digit on the right hand side of the two-digit sorting window.

In particular to the example shown in FIG. 3C, the window sorter module utilizes a first sorting window 316 that begins at objects A₁, A₂ of the first sub-array 302 and a second sorting window 316 that begins at objects B₄ and B₅ of the second sub-array 304. Therefore, as discussed above with respect to the example, the sorting windows 316, 318 are initially positioned as far away from one another as possible. It should be noted, however, that this is not limiting and the window sorting module 220 can place one or more of the sorting windows at another position on either of the sub-arrays 302, 304.

As shown in FIG. 3C, the first sorting window 316 begins comparing the digits at A₁ (digit value 3) and A₂ (digit value 2) in accordance with the comparison rule. Based on the above comparison rule, the first sorting window 316 will swap digits 2 and 3 with respect to objects A₁ and A₂. This change is reflected in FIG. 3D where digit 2 is now shown in object A₁ and digit 3 is now shown in object A₂. Simultaneously, as shown in FIG. 3C, the second sorting window 318 begins comparing the digits at B₄ (digit value 8) and B₅ (digit value 2) in accordance with the comparison rule. Based on the above comparison rule, the second sorting window 318 will swap digits 8 and 3 with respect to their objects B₄ and B₅. This change is reflected in FIG. 3D where digit 2 is now shown in object B₄ and digit 8 is now shown in object B₅.

Moving on to FIG. 3D, the process continues where the first sorting window 316 incrementally moves to the next object to the right of the sub-array 302 and compares (and potentially swaps) the digits in adjacent objects A₂ (digit value 3) and A₃ (digit value 4) in accordance with the comparison rule. Based on the above comparison rule, the first sorting window 316 will not swap digits 3 and 4 and will move to the right by one object, as shown in FIG. 3E. Also shown in FIG. 3D is that the second sorting window 318 incrementally moves to the next object to the left of the sub-array 304 and compares (and potentially swaps) the digits in adjacent objects B₃ (digit value 9) and B₄ (digit value 2) in accordance with the comparison rule. Based on the above comparison rule, the second sorting window 318 will swap digits 9 and 2 such that digit 2 will now be in object B₃ and digit 9 will now be in object B₄, as shown in FIG. 3E. The second sorting window 318 thereafter incrementally moves to the left by one object.

As shown in FIG. 3E, the process continues where after the first sorting window 316 incrementally moves to the next object to the right, it compares (and potentially swaps) the digits in adjacent objects A₃ (digit value 4) and A₄ (digit value 7) in accordance with the comparison rule. Based on the above comparison rule, the first sorting window 316 will not swap digits 4 and 7 and will move to the right by one object, as shown in FIG. 3F. Simultaneously, the second sorting window 318 compares (and potentially swaps) the digits in adjacent objects B₂ (digit value 6) and B₃ (digit value 2) in accordance with the comparison rule. Based on the above comparison rule, the second sorting window 318 will swap digits 6 and 2 such that digit 2 will now be in object B₂ and digit 6 will now be in object B₃ as shown in FIG. 3F. The second sorting window 318 thereafter incrementally moves to the left by one object.

As shown in FIG. 3F, the process continues where the first sorting window 316 compares (and potentially swaps) the digits in adjacent objects A₄ (digit value 7) and A₅ (digit value 1) in accordance with the comparison rule. Based on the above comparison rule, the first sorting window 316 will swap digits 7 and 1 such that digit 1 will now be in object A₄ and digit 7 will now be in object A₅ as shown in FIG. 3G. The first sorting window 316 thereafter incrementally moves to the right by one object and will thereby compare objects between the two sub-arrays 302, 304, as shown in FIG. 3G. Simultaneously, the second sorting window 318 compares (and potentially swaps) the digits in adjacent objects B₁ (digit value 10) and B₂ (digit value 2) in accordance with the comparison rule. Based on the above comparison rule, the second sorting window 318 will swap digits 10 and 2 such that digit 2 will now be in object B₁ and digit 10 will now be in object B₂ as shown in FIG. 3G. The second sorting window 318 thereafter incrementally moves to the left by one object and will thereby compare objects between the two sub-arrays 302, 304, as shown in FIG. 3G.

As shown in FIG. 3G, the first sorting window 316, upon reaching the end of its originating sub-array 302, will continue the adjacent-object digit sorting process by analyzing the digits contained in adjacent objects in the second sub-array 304. Similarly, the second sorting window 318, upon reaching the end of its originating sub-array 304, will continue the adjacent-object digit sorting process by analyzing the digits contained in adjacent objects in the first sub-array 302. As shown in FIG. 3G, the first sorting window 316 performs the adjacent-object digit sorting process wherein the objects that are analyzed by the first sorting window 316 are adjacently positioned across two sub-arrays. The same applies to the second sorting window 318. In the example shown in FIG. 3G, both sorting windows 316, 318 arrive and overlap at the same object position at the same time. This is due to each sub-array being the same length, both sorting windows being of the same digit size, both sorting windows moving at the same incremental pace, etc.

With regard to the comparison step, both (or only one) sorting window compares the digit value 7 in object A₅ with the digit value 2 in object B₁. According to the comparison rule described above, either the window sorting module 220 will swap digits 7 and 2 such that digit value 2 will be placed in object A₅ and digit value 7 will be placed in object B₁, as reflected in FIG. 3H.

As shown in FIG. 3H, the process continues where the first sorting window 316 has incrementally moved to the right by one object and is comparing (and potentially swapping) digits in adjacent objects in the second sub-array 304. Similarly, the second sorting window 318 has incrementally moved to the left by one object and is comparing (and potentially swapping) digits in adjacent objects in the first sub-array 302. Thus, within this example, it will be seen within the Figures that the first and second sorting windows 316, 318 move in a diverging fashion away from one another after they overlap, as shown in FIG. 3G.

Within FIG. 3H, the first sorting window 316 compares (and potentially swaps) digits in objects B₁ (digit value 7) and B₂ (digit value 10) in accordance with the comparison rule. Based on the above comparison rule, the first sorting window 316 does not swap digits 7 and 10 and thereafter incrementally moves to the right by one object, as shown in FIG. 3I. Simultaneously, the second sorting window 318 compares (and potentially swaps) the digits in adjacent objects A₄ (digit value 1) and A₅ (digit value 2) in accordance with the comparison rule. Based on the above comparison rule, the second sorting window 318 does not swap digits 1 and 2 and thereafter incrementally moves to the left by one object, as shown in FIG. 3I.

As shown in FIG. 3I, the first sorting window 316 compares the digit value 10 in object B₂ with digit value 6 in object B₃ in accordance with the comparison rule. Based on the above comparison rule, the first sorting window 316 will swap digits 10 and 6 such that digit 6 will be moved to object B₂ and digit 10 will be moved to object B₃, as shown in FIG. 3J. The first sorting window 316 thereafter incrementally moves to the right by one object. Simultaneously, the second sorting window 318 compares the digit value 4 in object A₃ with digit value 1 in object A₄ in accordance with the comparison rule. Based on the above comparison rule, the second sorting window 318 swaps digits 4 and 1 such that digit 1 is moved to object A₃ and digit 4 is moved to object A₄, as shown in FIG. 3J.

In FIG. 3J, the first sorting window 316 compares the digit value 10 in object B₃ with digit value 9 in object B₄ in accordance with the comparison rule. Based on the above comparison rule, the first sorting window 316 will swap digits 10 and 9 such that digit 9 is moved to object B₃ and digit 10 is moved to object B₄, as shown in FIG. 3K. The first sorting window 316 thereafter incrementally moves to the right by one object. Simultaneously, the second sorting window 318 compares the digit value 3 in object A₂ with digit value 1 in object A₃ in accordance with the comparison rule. Based on the above comparison rule, the second sorting window 318 swaps digits 3 and 1 such that digit 1 is moved to object A₂ and digit 3 is moved to object A₃, as shown in FIG. 3K. The second sorting window 318 thereafter incrementally moves to the left by one object.

In FIG. 3K, the first sorting window 316 compares the digit value 10 in object B₄ with digit value 8 in object B₅ in accordance with the comparison rule. Based on the above comparison rule, the first sorting window 316 will swap digits 10 and 8 such that digit 8 is moved to object B₄ and digit 10 is moved to object B₅, as shown in FIG. 3L. Simultaneously, the second sorting window 318 compares the digit value 2 in object A₁ with digit value 1 in object A₂ in accordance with the comparison rule. Based on the above comparison rule, the second sorting window 318 swaps digits 2 and 1 such that digit 1 is moved to object A₁ and digit 2 is moved to object A₂, as shown in FIG. 3L.

As shown in FIG. 3L, both sorting windows 316, 318 have reached the ends of their respective sub-arrays 302, 304. At this point, the second iteration is completed and the window sorting module 220 checks and analyzes the modified array (or sub-arrays) to determine if the entire array is sorted (Block 414 in FIG. 4). This is done using known techniques, and details of this process are not discussed herein. Thus, if the window sorting module 220 determines that the digits of the entire array (from O₁-Oₙ) are sorted in compliance with the desired sorted arrangement, the process terminates and the sub-arrays are combined into the modified array (End Block in FIG. 4).

In contrast, if the window sorting module 220 determines that the entire array is not sorted in compliance with the desired sorted arrangement, the window sorting module 220 initiates another iteration using the adjacent-object digit sorting process, described above. In the example shown, the window sorting module 220, upon analyzing sub-arrays 302 and 304, would conclude that if the sub-arrays were combined into a modified array, the digits would not be arranged in compliance with the desired sorted arrangement. As stated above, the desired sorted arrangement in this example is for the window sorting module 220 to sort the array such that the digits would be in an overall increasing sequential order. Accordingly, with respect to the present example, the window sorting module 220 initiates another iteration using the adjacent-object digit sorting process using multiple sorting windows. In an aspect, one or more of the multiple sorting windows is increased in digit size to compare (and potentially swap) digits between more than two adjacent objects (Block 416 in FIG. 4). In another aspect, one or more of the multiple sorting windows is remains the same digit size to compare (and potentially swap) digits between the same number of adjacent objects as was done in the previous iteration.

With respect to the example illustrated between FIGS. 3L-3T, the window sorting module 220 again utilizes two sorting windows 320, 322 in which each sorting window is increased in digit size to compare (and potentially swap) digits among three adjacent objects in accordance with a comparison rule.

In this example, in the window sorting module 220 performing the adjacent-object digit sorting process, each sliding window 320, 322 compares digits between three neighboring objects in accordance with a comparison rule. If the window sorter module, upon comparing the digits, determines that the rule has been satisfied, the window sorter module will swap or exchange the compared digits from their original objects to the new object. The comparison rule can be established and defined by a software engineer, network administrator, hardware designer and the like, whereby it is implemented in the window sorting module 220.
If digit_{Oi}>digit_{Oi+i}; then swap digits
If digit_{Oi+1}>digit_{Oi+2}; then swap digits
If digit_{Oi}<digit_{Oi+1}; then do not swap digits
If digit_{Oi+1}<digit_{Oi+2}; then do not swap digits
If digit_{Oi}=digit_{Oi+1}; then do not swap digits
If digit_{Oi+1}=digit_{Oi+2}; then do not swap digits

Where digit_{Oi} is in the object on the left hand side of the three-digit sorting window; digit_{Oi+2} is in the object on the right hand side of the three-digit sorting window; and digit_{Oi+1} is the digit in the object located between objects Oᵢ and Oᵢ₊₂. In an aspect, the sequence in which objects are compared (and potentially swapped) is based on the desired sorted arrangement implemented by the window sorting module 220. In particular to the example described herein, the window sorting module 220 compares (and potentially swaps) digit_{Oi} and digit_{Oi+1} and then compares (and potentially swaps) digit_{Oi+1} and digit_{Oi+2}. It should be noted that other sequences can be employed by the window sorting module 220 is thus not limited to the example discussed herein.

Referring to FIG. 3L, the first sorting window 320 compares the digit value 1 in object A₁ with digit value 2 in object A₂ in accordance with the above comparison rule. Based on the above comparison rule, the first sorting window 320 does not swap digits 1 and 2. The first sorting window 320 thereafter compares the digit value 2 in object A₂ with digit value 3 in object A₃ in accordance with the above comparison rule. Based on the above comparison rule, the first sorting window 320 does not swap digits 2 and 3 and moves to the right by one object, as shown in FIG. 3M.

Simultaneously, the second sorting window 322 compares the digit value 9 in object B₃ with digit value 8 in object B₄ in accordance with the comparison rule. Based on the above comparison rule, the second sorting window 322 swaps digits 8 and 9 such that digit 8 is moved to object B₃ and digit 9 is moved to object B₄, as shown in FIG. 3M. Additionally, the second sorting window 322 compares the newly moved digit value 9 (now located in object B₄) with the digit value 10 in object B₅. Based on the above comparison rule, the second sorting window 322 does not swap digits 9 and 10 and moves to the left by one object, as shown in FIG. 3M.

Referring now to FIG. 3M, the first sorting window 320 compares the digit value 2 in object A₂ with digit value 3 in object A₃ in accordance with the above comparison rule. Based on the above comparison rule, the first sorting window 320 does not swap digits 2 and 3. The first sorting window 320 thereafter compares the digit value 3 in object A₃ with digit value 4 in object A₄ in accordance with the above comparison rule. Based on the above comparison rule, the first sorting window 320 does not swap digits 3 and 4 and moves to the right by one object, as shown in FIG. 3N.

Simultaneously, the second sorting window 322 compares the digit value 6 in object B₂ with digit value 8 in object B₃ in accordance with the comparison rule. Based on the above comparison rule, the second sorting window 322 does not swap digits 6 and 8. Additionally, the second sorting window 322 compares the digit value 8 in object B₃ with the digit value 9 in object B₄. Based on the above comparison rule, the second sorting window 322 does not swap digits 8 and 9 and moves to the left by one object, as shown in FIG. 3N.

Referring now to FIG. 3N, the first sorting window 320 compares the digit value 3 in object A₃ with digit value 4 in object A₄ in accordance with the above comparison rule. Based on the above comparison rule, the first sorting window 320 does not swap digits 3 and 4. The first sorting window 320 thereafter compares the digit value 4 in object A₄ with digit value 2 in object A₅ in accordance with the above comparison rule. Based on the above comparison rule, the first sorting window 320 swaps digits 4 and 2 such that digit 2 is moved to object A₄ and digit 4 is moved to object A₅, as shown in FIG. 3O.

Simultaneously, the second sorting window 322 compares the digit value 7 in object B₁ with digit value 6 in object B₂ in accordance with the comparison rule. Based on the above comparison rule, the second sorting window 322 swaps digits 7 and 6 such that digit 6 is moved to object B₁ and digit 7 is moved to object B₂, as shown in FIG. 3O. Additionally, the second sorting window 322 compares the newly moved digit 7 (now in object B₂) with the digit value 8 in object B₃. Based on the above comparison rule, the second sorting window 322 does not swap digits 7 and 8 and moves to the left by one object, as shown in FIG. 3O.

As shown in FIG. 3O, the first sorting window 320, upon reaching the end of its originating sub-array 302, will continue the adjacent-object digit sorting process by analyzing digits contained in adjacent objects between the first and second sub-arrays 302, 304. Similarly, the second sorting window 322, upon reaching the end of its originating sub-array 304, will continue the adjacent-object digit sorting process by analyzing the digits contained in adjacent objects between the first and second sub-arrays 302, 304.

In the example shown in FIG. 3O, both sorting windows 320, 322 arrive and at least partially overlap over one or more of the same objects at the same time. With regard to the comparison step in FIG. 3O, the first sorting window 320 compares the digit value 2 in object A₄ with the digit value 4 in object A₅. According to the comparison rule described above, the first sorting window 320 will not swap digits 2 and 4. Additionally, the first sorting window 320 compares the digit value 4 in object A₅ with the digit value 6 in object B₁ and does not swap digit values 4 and 6 based on the above comparison rule. The first sorting window 320 thereafter moves to the right by one object, as shown in FIG. 3P.

Simultaneously, as shown in FIG. 3O, the second sorting window 322 compares the digit value 4 in object A₅ with the digit value 6 in object B₁ and does not swap digits 4 and 6 according to the comparison rule. Additionally, the second sorting window 322 compares the digit value 6 in object B₁ with the digit value 7 in object B₂ and does not swap digit values 6 and 7 based on the above comparison rule. The second sorting window 322 thereafter moves to the left by one object, as shown in FIG. 3P.

As shown in FIG. 3P, the first sorting window 320 compares the digit value 4 in object A₅ with the digit value 6 in object B₁ and does not swap digits 4 and 6 according to the comparison rule. Additionally, the first sorting window 320 compares the digit value 6 in object B₁ with the digit value 7 in object B₂ and does not swap digit values 6 and 7 based on the above comparison rule. The first sorting window 320 thereafter moves to the right by one object, as shown in FIG. 3Q.

Simultaneously, the second sorting window 322 compares the digit value 2 in object A₄ with the digit value 4 in object A₅. According to the comparison rule described above, the second sorting window 322 will not swap digits 2 and 4. Additionally, the second sorting window 322 compares the digit value 4 in object A₅ with the digit value 6 in object B₁ and does not swap digit values 4 and 6 based on the above comparison rule. The second sorting window 322 thereafter moves to the left by one object, as shown in FIG. 3Q.

Referring now to FIG. 3Q, the first sorting window 320 compares the digit value 6 in object B₁ with digit value 7 in object B₂ and does not swap these digits in accordance with the above comparison rule. The first sorting window 320 thereafter compares the digit value 7 in object B₂ with digit value 8 in object B₃ and does not swap these digits in accordance with the above comparison rule. The first sorting window 320 thereafter moves to the right by one object, as shown in FIG. 3R.

Simultaneously, the second sorting window 322 compares the digit value 3 in object A₃ with digit value 2 in object A₄ in accordance with the comparison rule. Based on the above comparison rule, the second sorting window 322 swaps digits 3 and 2 such that digit 2 is moved to object A₃ and digit 3 is moved to object A₄, as shown in FIG. 3R. Additionally, the second sorting window 322 compares the newly moved digit 3 (now in object A₄) with the digit value 4 in object A₅ and does not swap these digits based on the above comparison rule. The second sorting window 322 thereafter moves to the left by one object, as shown in FIG. 3R.

In FIG. 3R, the first sorting window 320 compares the digit value 7 in object B₂ with digit value 8 in object B₃ and does not swap these digits in accordance with the above comparison rule. The first sorting window 320 thereafter compares the digit value 8 in object B₃ with digit value 9 in object B₄ and does not swap these digits in accordance with the above comparison rule. The first sorting window 320 thereafter moves to the right by one object, as shown in FIG. 3S.

Simultaneously, the second sorting window 322 compares the digit value 2 in object A₂ with digit value 2 in object A₃ and does not swap these two values in accordance with the comparison rule. Considering that both digits have the same value, it is contemplated that the window sorting module 220 may swap the values away, although the result will be the same. The second sorting window 322 also compares but does not swap digits 2 and 3 (in corresponding objects A₃ and A₄) in accordance with the above comparison rule. The second sorting window 322 thereafter moves to the left by one object, as shown in FIG. 3S.

In FIG. 3S, the first sorting window 320 compares, but does not swap, digit values 8 and 9 as well as digit values 9 and 10 in accordance with the above comparison rule. Simultaneously, the second sorting window 322 compares but does not swap digit values 1, 2 and 2 in accordance with the comparison rule.

As shown in FIG. 3S, both sorting windows 320, 322 have reached the ends of their respective sub-arrays 302, 304. At this point, the third iteration is completed and the window sorting module 220 checks and analyzes the modified array (or sub-arrays) to determine if the entire array is sorted. This is done using known techniques and details of this process is not discussed herein. If the window sorting module 220 determines that all of the digits in the entire array from O₁-Oₙ are sorted in compliance with the desired sorted arrangement, the process terminates and the sub-arrays are combined into the modified array 300′, as shown in FIG. 3T. In the present example, the window sorting module 220 will determine that the entire modified array 300′ complies with the desired sorted arrangement and the process terminates. The modified array 300′ is then output to the desired software or hardware component for further processing, which is not discussed herein.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A method of providing a window sorting mechanism, the method comprising:
executing a window sorting mechanism implemented on a network device;
receiving an array having a plurality of objects, each object containing a digit, wherein the digits in the received array are unsorted in association with a desired sorting arrangement;
determining a length of the received array using one or more processors;
separating, using the one or more processors, the received array into a plurality of sub-arrays based on the length of the received array, wherein at least two sub-arrays comprise a first sub-array and a second sub-array, the first and second sub-arrays having an equal number of objects;
performing, using the one or more processors, an inter sub-array digit sorting process in a first iteration between the first sub-array and the second sub-array to sort digits in correspondingly positioned objects of the first and second sub-arrays in accordance with a first comparison rule;
performing, using the one or more processors, a first adjacent-object digit sorting process in a second iteration on at least the first and second sub-arrays using a plurality of sorting windows of a first determined digit size, wherein at least two sorting windows simultaneously sort digits in adjacent objects in the first and second sub-arrays in accordance with a second comparison rule to produce a first modified array.

2. The method of claim 1, further comprising:
determining if the modified array contains digits sorted in compliance with the desired sorting arrangement after the second iteration;
performing a second adjacent-object digit sorting process in a third iteration on at least the first and second sub-arrays using a plurality of sorting windows of a second determined digit size, wherein at least two sorting windows simultaneously sort digits in adjacent objects in the first and second sub-arrays in accordance with a third comparison rule to produce a second modified array having digits sorted in compliance with the desired sorting arrangement; and
outputting the second modified array.

3. The method of claim 1, wherein the first determined digit size comprises a two digit sorting window.

4. The method of claim 2, wherein the second determined digit size comprises a three digit sorting window.

5. The method of claim 1, wherein the performing of the first adjacent-object digit sorting process further comprises:
comparing a first pair of digits in a first pair of adjacent objects in at least the first sub-array using the first sorting window according to the second comparison rule; and
swapping the digits in the first pair if the values of the digits satisfy the second comparison rule.

6. The method of claim 1, wherein the performing of the first adjacent-object digit sorting process further comprises:
comparing a second pair of digits in a second pair of adjacent objects in at least the second sub-array using the second sorting window according to the second comparison rule; and
swapping the digits in the second pair if the values of the digits satisfy the second comparison rule.

7. The method of claim 1, wherein the performing of the first adjacent-object digit sorting process further comprises:
moving the first and second sorting windows incrementally along the first and second sub-arrays toward one another in a converging fashion;
overlapping the first and second sorting windows on one or more objects of the first and second sorting windows; and
moving the first and second sorting windows incrementally along the first and second sub-arrays away one another in a diverging fashion.

8. A non-transitory machine readable medium having stored thereon instructions for providing a window sorting module, comprising machine executable code which when executed by at least one machine, causes the machine to:
execute a window sorting mechanism implemented on a network device;
receive an array having a plurality of objects, each object containing a digit, wherein the digits in the received array are unsorted in association with a desired sorting arrangement;
determine a length of the received array;
separate the received array into a plurality of sub-arrays based on the length of the received array, wherein at least two sub-arrays comprise a first sub-array and a second sub-array, the first and second sub-arrays having an equal number of objects;
perform an inter sub-array digit sorting process in a first iteration between the first sub-array and the second sub-array to sort digits in correspondingly positioned objects of the first and second sub-arrays in accordance with a first comparison rule;
perform a first adjacent-object digit sorting process in a second iteration on at least the first and second sub-arrays using a plurality of sorting windows of a first determined digit size, wherein at least two sorting windows simultaneously sort digits in adjacent objects in the first and second sub-arrays in accordance with a second comparison rule to produce a first modified array.

9. The machine readable medium of claim 8, wherein the machine executable code which when executed by at least one machine, causes the machine to:
determine if the modified array contains digits sorted in compliance with the desired sorting arrangement after the second iteration;
perform a second adjacent-object digit sorting process in a third iteration on at least the first and second sub-arrays using a plurality of sorting windows of a second determined digit size, wherein at least two sorting windows simultaneously sort digits in adjacent objects in the first and second sub-arrays in accordance with a third comparison rule to produce a second modified array;
output the second modified array.

10. The machine readable medium of claim 8, wherein the first determined digit size comprises a two digit sorting window.

11. The machine readable medium of claim 8, wherein the second determined digit size comprises a three digit sorting window.

12. The machine readable medium of claim 8, wherein the machine executable code which when executed by at least one machine, causes the machine to:
compare a first pair of digits in a first pair of adjacent objects in at least the first sub-array using the first sorting window according to the second comparison rule; and
swap the digits in the first pair if the values of the digits satisfy the second comparison rule.

13. The machine readable medium of claim 8, wherein the machine executable code which when executed by at least one machine, causes the machine to:
compare a second pair of digits in a second pair of adjacent objects in at least the second sub-array using the second sorting window according to the second comparison rule;
swap the digits in the second pair if the values of the digits satisfy the second comparison rule.

14. The machine readable medium of claim 8, wherein the machine executable code which when executed by at least one machine, causes the machine to:
move the first and second sorting windows move incrementally along the first and second sub-arrays toward one another in a converging fashion;
overlap the first and second sorting windows on one or more objects of the first and second sorting windows; and
move the first and second sorting windows move incrementally along the first and second sub-arrays away one another in a diverging fashion.

15. A computer system comprising:
a network interface configured to allow communications between the computing system and one or more network devices;
a memory;
a processor coupled to the network interface and the memory, the processor operative to:
execute a window sorting mechanism implemented on a network device;
receive an array having a plurality of objects, each object containing a digit, wherein the digits in the received array are unsorted in association with a desired sorting arrangement;
determine a length of the received array;
separate the received array into a plurality of sub-arrays based on the length of the received array, wherein at least two sub-arrays comprise a first sub-array and a second sub-array, the first and second sub-arrays having an equal number of objects;
perform an inter sub-array digit sorting process in a first iteration between the first sub-array and the second sub-array to sort digits in correspondingly positioned objects of the first and second sub-arrays in accordance with a first comparison rule;
perform a first adjacent-object digit sorting process in a second iteration on at least the first and second sub-arrays using a plurality of sorting windows of a first determined digit size, wherein at least two sorting windows simultaneously sort digits in adjacent objects in the first and second sub-arrays in accordance with a second comparison rule to produce a first modified array.

16. The computer system of claim 15, wherein the processor is configured to
determine if the modified array contains digits sorted in compliance with the desired sorting arrangement after the second iteration;
perform a second adjacent-object digit sorting process in a third iteration on at least the first and second sub-arrays using a plurality of sorting windows of a second determined digit size, wherein at least two sorting windows simultaneously sort digits in adjacent objects in the first and second sub-arrays in accordance with a third comparison rule to produce a second modified array;
output the second modified array.

17. The computer system of claim 15, wherein the first determined digit size comprises a two digit sorting window.

18. The computer system of claim 15, wherein the second determined digit size comprises a three digit sorting window.

19. The computer system of claim 15, wherein the processor is configured to:
compare a first pair of digits in a first pair of adjacent objects in at least the first sub-array using the first sorting window according to the second comparison rule; and
swap the digits in the first pair if the values of the digits satisfy the second comparison rule.

20. The computer system of claim 15, wherein the processor is configured to:
compare a second pair of digits in a second pair of adjacent objects in at least the second sub-array using the second sorting window according to the second comparison rule; and
swap the digits in the second pair if the values of the digits satisfy the second comparison rule.

21. The computer system of claim 15, wherein the processor is configured to:
move the first and second sorting windows move incrementally along the first and second sub-arrays toward one another in a converging fashion; and
overlap the first and second sorting windows on one or more objects of the first and second sorting windows; and
move the first and second sorting windows move incrementally along the first and second sub-arrays away one another in a diverging fashion.
